(19) United States
(12) Patent Application Publication
(10) Pub. No.: US 2023/0314794 A1
(43) Pub. Date: Oct. 5, 2023

(54) POST-PROCESSING OPTICAL LOSS RECOVERY METHODS

(71) Applicant: Meta Platforms Technologies, LLC, Menlo Park, CA (US)

(72) Inventors: Joshua Andrew Kaitz, Woodinville, WA (US); Pasqual Rivera, Woodinville, WA (US); Guangbi Yuan, Redmond, WA (US); Nihar Ranjan Mohanty, Snoqualmie, WA (US); John Sporre, Bothell, WA (US); Vivek Gupta, Sammamish, WA (US)

(21) Appl. No.: 18/159,842

(22) Filed: Jan. 26, 2023

Related U.S. Application Data
(60) Provisional application No. 63/325,882, filed on Mar. 31, 2022.

(51) Int. Cl. G02B 27/00; G02B 27/01

(52) U.S. Cl. CPC G02B 27/0006; G02B 27/017

(57) ABSTRACT

The disclosed method for recovering optical properties of transparent substrates may include performing a post-etching annealing process on a transparent substrate. The method may also include applying a plasma treatment to the transparent substrate, performing an atomic layer etching treatment on the transparent substrate, and/or performing a cleaning process. Various other methods, devices, and systems are also disclosed.

### CROSS REFERENCE TO RELATED APPLICATION

This application claims the benefit of U.S. Provisional Application No. 63/325,882, filed 31 Mar. 2022, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example method for post-processing optical loss recovery.

FIG. 2 illustrates an example test process for post-processing optical loss recovery.

FIG. 3 illustrates example post-etching optical loss.

FIG. 4 illustrates example post-processing optical loss recovery.

FIG. 5 illustrates example post-processing optical loss recovery.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Substrates with optical properties (e.g., transparent substrates) may be used in manufacturing a variety of structures and apparatuses with optical properties, such as waveguides. However, some manufacturing processes applied to substrates (e.g., etching processes, such as reactive-ion etching and ion-beam etching) may cause undesired changes to the substrates, such as inducing surface roughness and/or changing the surface composition. These changes may interfere with optical properties of the substrates, such as transmittance, refractive index, and scattering loss.

The present disclosure describes various manufacturing processes for recovering transparent substrates after initial processing. These processes may restore and/or improve the optical properties of a substrate by, e.g., reducing surface roughness, restoring and/or modifying the surface composition of the substrate, etc. Treatments described herein may include, without limitation, oxidative or reductive annealing, plasma treatments, atomic layer etching, cleaning treatments, and/or applying a surface passivation layer.

A transparent substrate may include any of a variety of materials, including, without limitation, lithium niobate, zinc sulfide, indium tin oxide, aluminum oxide, titanium oxide, hafnium oxide, silicon carbide, quartz, diamond, and/or glass.

In some examples, a treatment for recovering and/or improving a transparent substrate after initial processing (e.g., etching, such as ion-beam etching), may include performing an oxidative annealing on the substrate. In some examples, the oxidative annealing may be performed at a temperature between 10 degrees Celsius and 1200 degrees Celsius. In some examples, the oxidative annealing may be performed at a temperature between 10 degrees Celsius and 1400 degrees Celsius. In some examples, the oxidative annealing may be performed at a temperature between 10 degrees Celsius and 1600 degrees Celsius. In some examples, the oxidative annealing may be performed at a temperature between 1200 degrees Celsius and 1400 degrees Celsius.

Additionally or alternatively, a method for recovering and/or improving a transparent substrate after initial processing may include performing a reductive annealing on the substrate. In some examples, the reductive annealing may be performed at a temperature between 10 degrees Celsius and 1200 degrees Celsius. In some examples, the reductive annealing may be performed at a temperature between 10 degrees Celsius and 1400 degrees Celsius. In some examples, the reductive annealing may be performed at a temperature between 10 degrees Celsius and 1600 degrees Celsius. In some examples, the reductive annealing may be performed at a temperature between 1200 degrees Celsius and 1400 degrees Celsius.

The annealing steps described herein may be performed within any suitable environment. In some examples, the annealing steps described herein may be performed in Ar gas, in H2 gas, or in a mix thereof. By way of examples, without limitation, the annealing steps may be performed in an H2/Ar gas mixture with 3 percent H2 or less by volume, 4 percent H2 or less, 5 percent H2 or less, 10 percent H2 or less, and/or between 1 and 4 percent H2. In some examples, the gas composition may include one or more oxidative gases (e.g., steam, O₂), one or more inert gases (e.g., Ar, N2), and/or one or more reductive gases (NH3, CH4).

The annealing steps described herein may be performed under any suitable amount of pressure. By way of examples, without limitation, the annealing steps described herein may be performed under pressure between 0.01 atmospheres to 1 atmosphere. In some examples, the annealing steps described herein may be performed at above 1 atmosphere. In some examples, the annealing steps described herein may be performed at between 400 and 600 torr, between 300 and 700 torr, between 200 and 800 torr, and/or between 100 and 900 torr.

In some examples, in addition to and/or instead of performing one or more annealing steps, the method may include performing a plasma treatment on the substrate. For example, the method may include performing an oxidative plasma treatment on the substrate. Additionally or alternatively, the method may include performing a reductive plasma treatment on the substrate. The plasma treatment may include any form of oxidative plasma treatment and/or reductive plasma treatment. The plasma treatment may suitable type of plasma, including, without limitation, argon-based plasmas, helium-based plasmas, nitrogen-based plasmas, oxygen-based plasmas, and/or hydrogen-based plasmas.

In some examples, in addition to any combination of the steps described above, the method may include performing an atomic layer etch treatment on the substrate.

In some examples, the method may include both an oxidative and a reductive treatment, in sequence. In some examples, the method may first include an oxidative treatment and then a reductive treatment. In some examples, the method may first include a reductive treatment and then an oxidative treatment.

In some examples, in addition to any combination of the steps described above, the method may include cleaning the substrate (e.g., subsequent to the treatments described above).

In some examples, in addition to any combination of the steps described above, the method may include applying a surface passivation layer (e.g., subsequent to the treatments the described above). The surface passivation layer may be applied using any suitable deposition technique. For example, the surface passivation layer may be applied using atomic layer deposition.

As described above, in some examples a method for recovering and/or improving a transparent substrate after initial processing may include performing an oxidative annealing and/or cleaning process on the substrate. In this manner, the method may clean surface contaminants from the substrate and reintroduce a protective surface oxide layer to the substrate. The method may include any suitable oxidative annealing and/or cleaning process. In some examples, the method may include a dry oxidative process.

The dry oxidative process may be performed for any suitable amount of time. In some examples, the dry oxidative process may be performed for a period in the range of one second to 10 hours. In some examples, the dry oxidative process may be performed for a period in the range of one minute to two hours. The dry oxidative process may be performed at any suitable temperature. For example, the dry oxidative process may be performed at a temperature in the range of 10 degrees Celsius to 1200 degrees Celsius, in the range of 10 degrees Celsius to 1000 degrees Celsius, in the range of 10 degrees Celsius to 600 degrees Celsius, in the range of 10 degrees Celsius to 400 degrees Celsius, or in the range of 10 degrees Celsius to 100 degrees Celsius. The dry oxidative process may be performed at any suitable pressure. For example, the dry oxidative process may be performed at a pressure in the range of 0.1 torr to 100 torr. The dry oxidative process may be performed using any suitable oxidizing gasses. For example, the dry oxidative process may be performed using O₂, Ar, Cl₂, HBr, SF₆, N₂O, and/or CO₂. In some examples, the dry oxidative process may be performed using a mixture of gasses. For example, the dry oxidative process may be performed using a mixture of O₂ and Ar or using a mixture of O₂ and N₂.

The dry oxidative process may use radiofrequency plasma within any suitable range of power. For example, the dry oxidative process may use radiofrequency plasma between zero and six kilowatts. In addition, the dry oxidative process may be performed within any suitable range of bias power. For example, the dry oxidative process may be performed at between zero and six kilowatts of bias power.

As discussed above, a method for recovering and/or improving a transparent substrate after initial processing may include performing an oxidative annealing and/or cleaning process on the substrate. In some examples, the oxidative annealing and/or cleaning process may include a wet oxidative process.

The wet oxidative process may be performed in any suitable fashion and with any suitable parameters. For example, the wet oxidative process may include a cleaning process using a solution of sulfuric acid and hydrogen peroxide. For example, the wet oxidative process may use a piranha solution, a NANO-STRIP solution, etc.

The wet oxidative process may be performed at any suitable temperature. In some examples, the wet oxidative process may be performed within a range of temperatures between 10 degrees Celsius and 30 degrees Celsius. The wet oxidative process may be performed at any suitable level of relative humidity. In some examples, the wet oxidative process may be performed within a range of relative humidity from 10% to 100%.

In some examples, the wet oxidative process may include the application of hydrofluoric acid to the surface of the substrate. In some examples, the hydrofluoric acid may be applied within a temperature range of 10 degrees Celsius to 30 degrees Celsius.

In some examples, the wet oxidative process may include the application of water to the surface of the substrate. In some examples, the water may be applied within a temperature range of 100 degrees Celsius to 400 degrees Celsius.

In some examples, the wet oxidative process may include a steam annealing process. The steam annealing may be performed at any suitable temperature. For example, the steam annealing may be performed at a temperature in the range of 20 degrees Celsius to 1200 degrees Celsius.

As discussed above, a method for recovering and/or improving a transparent substrate after initial processing may include performing a reductive annealing and/or cleaning process on the substrate. In some examples, the reductive process may anneal out crystal defects and/or trap states from the substrate. Additionally or alternatively, the reductive process may cap reactive interfacial bonds. In some examples, the reductive annealing and/or cleaning process may include a dry reductive process.

The dry reductive process may be performed over any suitable length of time. In some examples, the dry reductive process may be performed for a duration within a range of one second to three hours. In some examples, the dry reductive process may be performed for a duration within a range of one minute to two hours.

The dry reductive process may be performed at any suitable temperature. For example, the dry reductive process may be performed at a temperature in the range of 10 degrees Celsius to 1200 degrees Celsius, in the range of 10 degrees Celsius to 1000 degrees Celsius, in the range of 10 degrees Celsius to 600 degrees Celsius, or in the range of 10 degrees Celsius to 400 degrees Celsius.

The dry reductive process may be performed at any suitable pressure. For example, the dry reductive process may be performed at a pressure in the range of 0.1 torr to 800 torr.

The dry reductive process may be performed using any suitable gas composition. For example, the dry reductive process may be performed using H2, a mixture of H₂ and N₂, a mixture of H₂ and Ar, NH₃, CO, a mixture of H₂ and He, and/or CH₄.

The dry reductive process may use radiofrequency plasma within any suitable range of power. For example, the dry reductive process may use radiofrequency plasma between zero and six kilowatts. In addition, the dry reductive process may be performed within any suitable range of bias power. For example, the dry reductive process may be performed at between zero and six kilowatts of bias power.

In some examples, a method for recovering and/or improving a transparent substrate after initial processing may include cleaning residual foreign material from the substrate by first applying an oxidative ash to the substrate and then performing a wet piranha clean of the substrate (e.g., using a solution of sulfuric acid and hydrogen peroxide).

In some examples, the oxidative ash may be performed using O₂. The oxidative ash may be performed at any suitable pressure. In some examples, the oxidative ash may be performed within a range of 100 millitorrs to 2 torrs. For example, the oxidative ash may be performed at about 500 millitorrs. The oxidative ash may include use of radiofrequency plasma within any suitable range of power. In some examples, the oxidative ash may include the use of radiofrequency plasma between 100 and 600 watts. In one example, the oxidative ash may include the use of radiofrequency plasma at about 300 watts. The oxidative ash may be performed for any suitable amount of time. In some examples, the oxidative ash may be performed for a period within the range of 1 minute to 10 minutes. In one example, the oxidative ash may be performed for about 4 minutes.

In some examples, the wet piranha clean may be performed for about 10 minutes. In some examples, the wet piranha clean may be performed at a temperature within a range of 10 degrees Celsius and 30 degrees Celsius.

In some examples, a method for recovering and/or improving a transparent substrate may include healing damage caused to the substrate during an ion-beam etching process by applying a plasma to the substrate using a mixture of H₂ and Ar. The H₂/Ar plasma may be applied at any suitable temperature. In some examples, the H₂/Ar plasma may be applied at a temperature in the range of 300 degrees Celsius to 600 degrees Celsius. In one example, the H₂/Ar plasma may be applied at about 400 degrees Celsius. The gasses may be applied at any suitable flow rate and/or ratio of flow rates. For example, in some examples the Ar gas may be applied at a greater flow rate than the H₂ gas. In various examples, the Ar gas may be applied at a flow rate at least 3 times greater than the H₂ gas, at least 5 times greater than the H₂ gas, or at least 7 times greater than the H₂ gas. In one example, the Ar gas may be applied at a flow rate of about 9 times greater than the H₂ gas. By way of example, the Ar gas may be applied at a flow rate of 135 standard cubic centimeters per minute while the H₂ gas may be applied at a flow rate of 15 standard cubic centimeters per minute.

The H₂/Ar plasma may be applied at any suitable power level. For example, the H₂/Ar plasma may be applied at a power level in the rage from 150 watts to 300 watts. In one example, the H₂/Ar plasma may be applied at a power level of about 200 watts. The H₂/Ar plasma may be applied under any suitable pressure. In some examples, the H₂/Ar plasma may be applied at a pressure within the range of 1 torr to 10 torrs. In one example, the H₂/Ar plasma may be applied at a pressure of about 4 torrs. The H₂/Ar plasma may be applied for any suitable amount of time. In some examples, the H₂/Ar plasma may be applied for a period with the range of 1 minute to 1 hour. In one example, the H₂/Ar plasma may be applied for a period of about 15 minutes.

In some examples, a method for recovering and/or improving a transparent substrate may first include applying a plasma to the substrate using a mixture of H₂ and Ar (e.g., according to any combination of the examples of applying a H₂/Ar plasma described above). The method may next include applying an oxidative plasma to the substrate. The oxidative plasma may use any suitable gas or combination of gasses, including, e.g., O₂ and Ar.

The oxidative plasma may be applied at any suitable temperature. In some examples, the oxidative plasma may be applied at a temperature in the range of 300 degrees Celsius to 600 degrees Celsius. In one example, the oxidative plasma may be applied at about 400 degrees Celsius. The gasses may be applied at any suitable flow rate and/or ratio of flow rates. For example, in some examples the Ar gas may be applied at a greater flow rate than the O₂ gas. In various examples, the Ar gas may be applied at a flow rate at least 1.5 times greater than the O₂ gas, at least 2 times greater than the H₂ gas, or at least 3 times greater than the O₂ gas. In one example, the Ar gas may be applied at a flow rate of about 4 times greater than the O₂ gas. By way of example, the Ar gas may be applied at a flow rate of 80 standard cubic centimeters per minute while the O₂ gas may be applied at a flow rate of 20 standard cubic centimeters per minute.

The oxidative plasma may be applied at any suitable power level. For example, the oxidative plasma may be applied at a power level in the rage from 150 watts to 300 watts. In one example, the oxidative plasma may be applied at a power level of about 200 watts. The oxidative plasma may be applied under any suitable pressure. In some examples, the oxidative plasma may be applied at a pressure within the range of 1 torr to 10 torrs. In one example, the oxidative plasma may be applied at a pressure of about 4 torrs. The oxidative plasma may be applied for any suitable amount of time. In some examples, the oxidative plasma may be applied for a period with the range of 1 minute to 1 hour. In one example, the oxidative plasma may be applied for a period of about 15 minutes.

The method may next include cleaning the substrate using a buffered oxide etching process. The buffered oxide etching process may include the application of a solution of ammonium fluoride and hydrofluoric acid. The buffered oxide etching process may be performed for any suitable amount of time. In some examples, the buffered oxide etching process may be performed fora period of time in the range of 1 minute to 1 hour. In some examples, the buffered oxide etching process may be performed for about 10 minutes. In some examples, the buffered oxide etching process may be performed at a temperature within a range of 10 degrees Celsius and 30 degrees Celsius.

In one example, a method for recovering and/or improving a transparent substrate following damage caused during an ion beam etching process may include applying an oxidative ash. In some examples, the oxidative ash may be performed using O₂. The oxidative ash may be performed at any suitable pressure. In some examples, the oxidative ash may be performed within a range of 100 millitorrs to 2 torrs. For example, the oxidative ash may be performed at about 500 millitorrs. The oxidative ash may include use of radiofrequency plasma within any suitable range of power. In some examples, the oxidative ash may include the use of radiofrequency plasma between 100 and 600 watts. In one example, the oxidative ash may include the use of radiofrequency plasma at about 300 watts. The oxidative ash may be performed for any suitable amount of time. In some examples, the oxidative ash may be performed for a period within the range of 1 minute to 10 minutes. In one example, the oxidative ash may be performed for about 4 minutes.

In some examples, the methods for recovering and/or improving a transparent substrate described herein may produce a transformed substrate. The transformed substrate may have undergone a manufacturing process (such as reactive-ion etching or ion-beam etching) and, nevertheless, maintain one or more optical properties to a specification near, at, or better than the substrate was before the manufacturing process. In some examples, the transformed substrate may operate as an optical waveguide. In some examples, such an optical waveguide may be used within an augmented reality device and/or a virtual reality device.

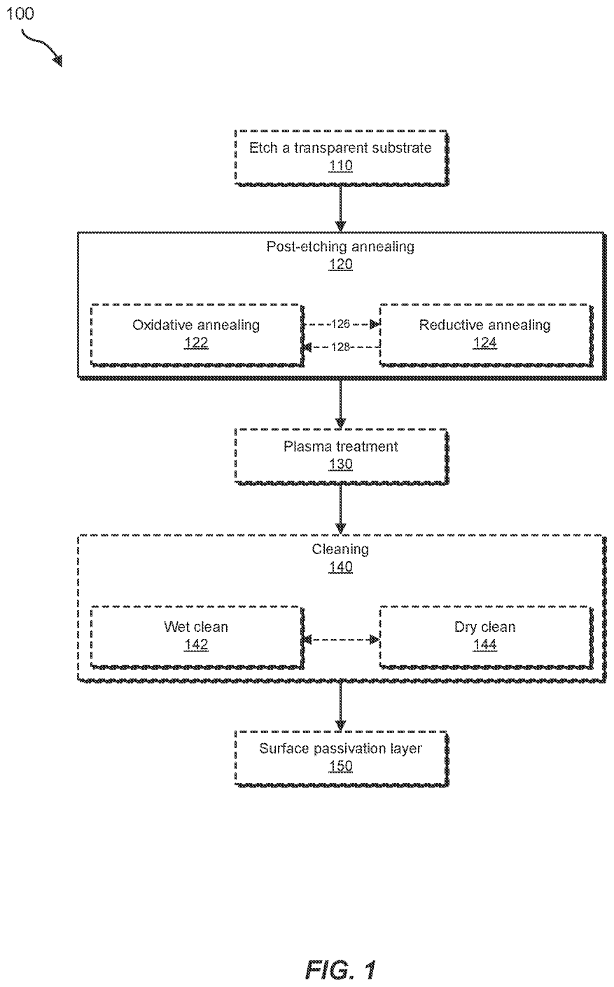

FIG. 1 illustrates an example method 100 for post-processing optical loss recovery. As shown in FIG. 1, at a step 110 method 100 may optionally include etching a transparent substrate. By way of example, the transparent substrate may be an optical waveguide in manufacture. In some examples, the method may start after an optical waveguide in manufacture has been etched.

At step 120, method 100 may include a post-etching annealing of the transparent substrate. The post-etching annealing may include an oxidative annealing step 122, a reductive annealing step 124, or both. If the post-etching annealing includes both step 122 and step 124, these steps may happen in any order (e.g., an order 126, in which step 122 is performed before step 124, or an order 128, in which step 124 is performed before step 122). The post-etching annealing of method 100 may include any of the techniques, conditions, and/or parameters for annealing described herein.

At step 130, method 100 may include a plasma treatment of the transparent substrate. In some examples, step 130 may be omitted from method 100. The plasma treatment of method 100 may include any of the techniques, conditions, and/or parameters for plasma treatments described herein.

At step 140, method 100 may include a cleaning of the transparent substrate. The cleaning may include a wet clean step 142 and/or a dry clean step 144. The wet clean step 142 and the dry clean step 144 may happen in any order. In some examples, step 140 may be omitted from method 100. The cleaning of method 100 may include any of the techniques, conditions, and/or parameters for cleaning described herein.

At step 150, method 100 may include applying a surface passivation layer to the transparent substrate. In some examples, step 150 may be omitted from method 100. The surface passivation layer step of method 100 may include any of the techniques, conditions, and/or parameters for applying a surface passivation layer described herein.

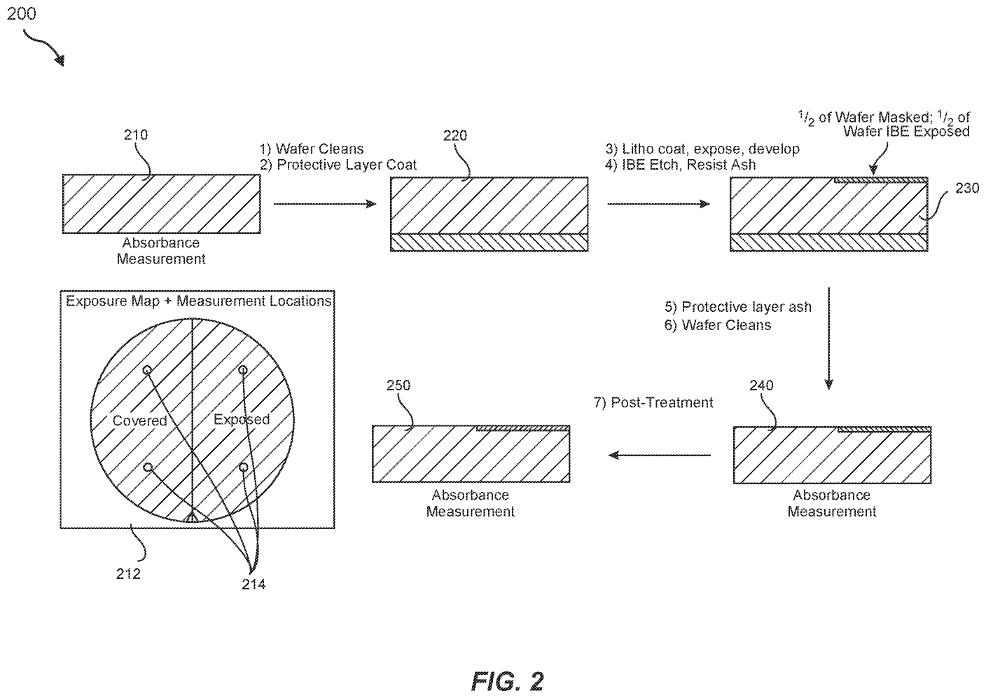

FIG. 2 illustrates an example test process 200 for post-processing optical loss recovery. As shown in FIG. 2, test process 200 may begin with a transparent substrate 210. The initial absorbance of transparent substrate 210 may be measured at one or more locations (e.g., such as the front and the back sides of transparent substrate 210 at locations 214, as shown on map 212). Transparent substrate 210 may be cleaned and a protective layer may be applied, resulting in a transparent substrate 220.

A photolithographic process may be performed on transparent substrate 220, after which an ion beam etching (IBE) may be performed on transparent substrate 220, followed by a resist ash process. Half of transparent substrate 220 may be masked, and half of transparent substrate 220 may be exposed to the etching process, resulting in transparent substrate 230.

A protecting layer ash process may be performed on transparent substrate 230, and a cleaning process may be performed on transparent substrate 230, resulting in a transparent substrate 240. An absorbance measurement of transparent substrate 240 may be taken at one or more locations (such as locations 214). After performing the absorbance measurement, one or more of the post-etch treatments described herein may be applied to transparent substrate 240, resulting in a transparent substrate 250. An absorbance measurement of transparent substrate 250 may be taken at one or more locations (such as locations 214).

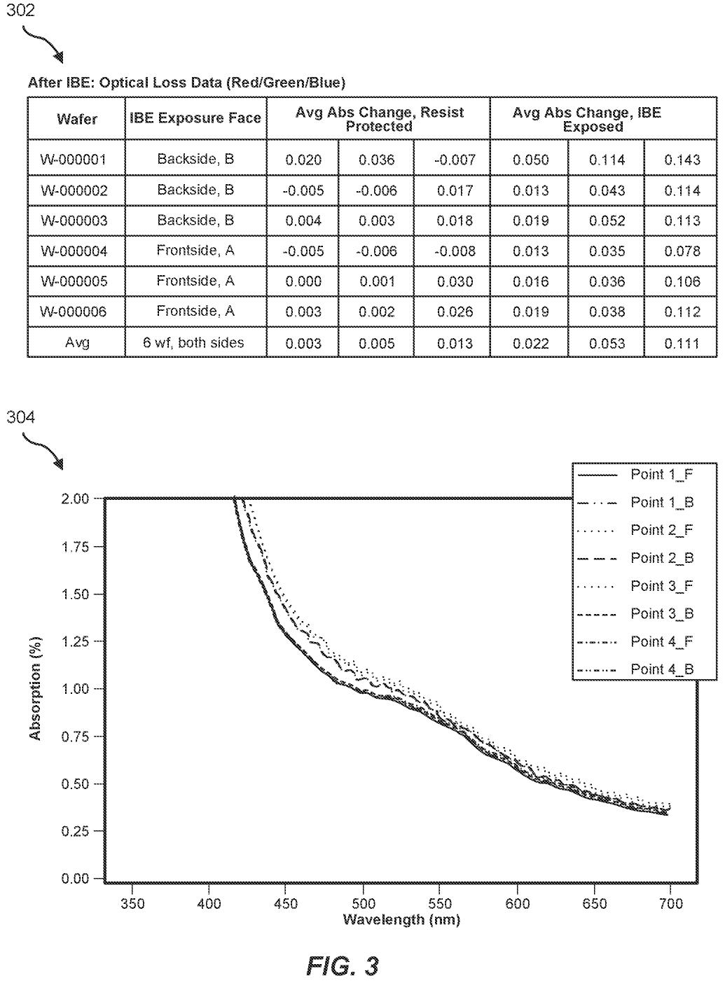

FIG. 3 illustrates example post-etching optical loss. As shown in FIG. 3, following an etching process (e.g., the etching process described with respect to FIG. 2), a transparent substrate may experience optical loss across wavelengths. For example, a table 302 shows transparent substrates experiencing an average absolute change in optical loss of between 0.078% and 0.143% following an etching process. A graph 304 shows absorption percentages across wavelengths as measured at various transparent substrate locations (such as locations 214 illustrated in map 212 of FIG. 2). For example, post-etching residue and increased surface roughness may contribute to optical loss. High optical loss may correlate to a negative impact in optical performance on various optical devices (e.g., throughput of waveguides).

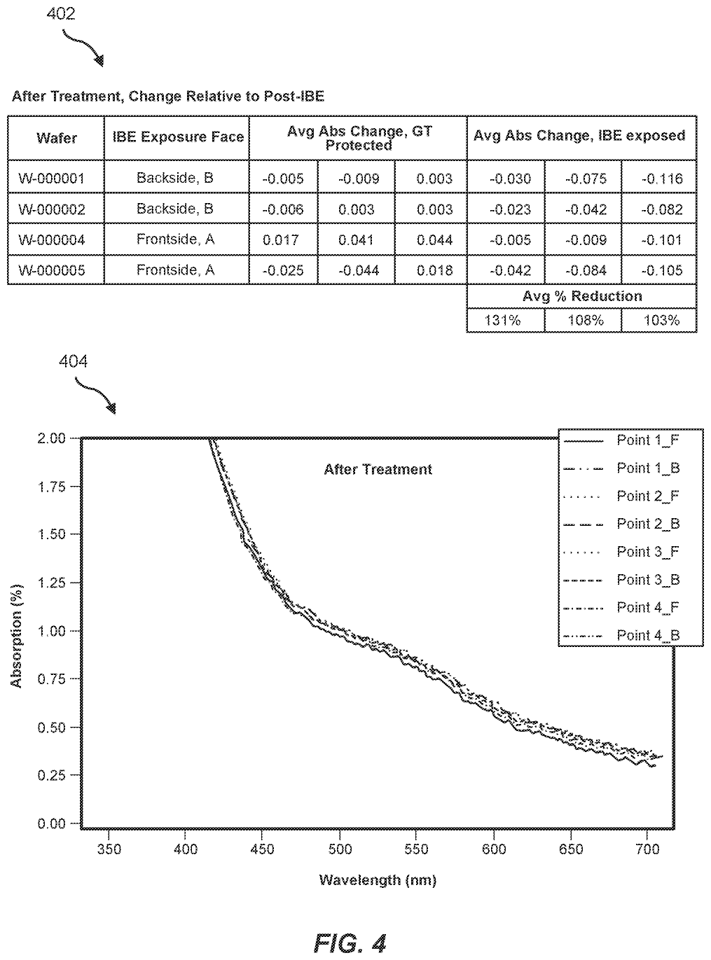

FIG. 4 illustrates example post-processing optical loss recovery. As shown in FIG. 4, following a post-etching recovery process (such as one or more of the treatments described herein), a transparent substrate may demonstrate reduced optical loss. For example, a table 402 shows transparent substrates experiencing an average reduction in optical loss of greater than 100% across wavelengths. A graph 404 shows absorption percentages across wavelengths as measured at various transparent substrate locations (such as locations 214 illustrated in map 212 of FIG. 2). Reduced optical loss may correlate to a positive impact in optical performance on various optical devices (e.g., throughput of waveguides).

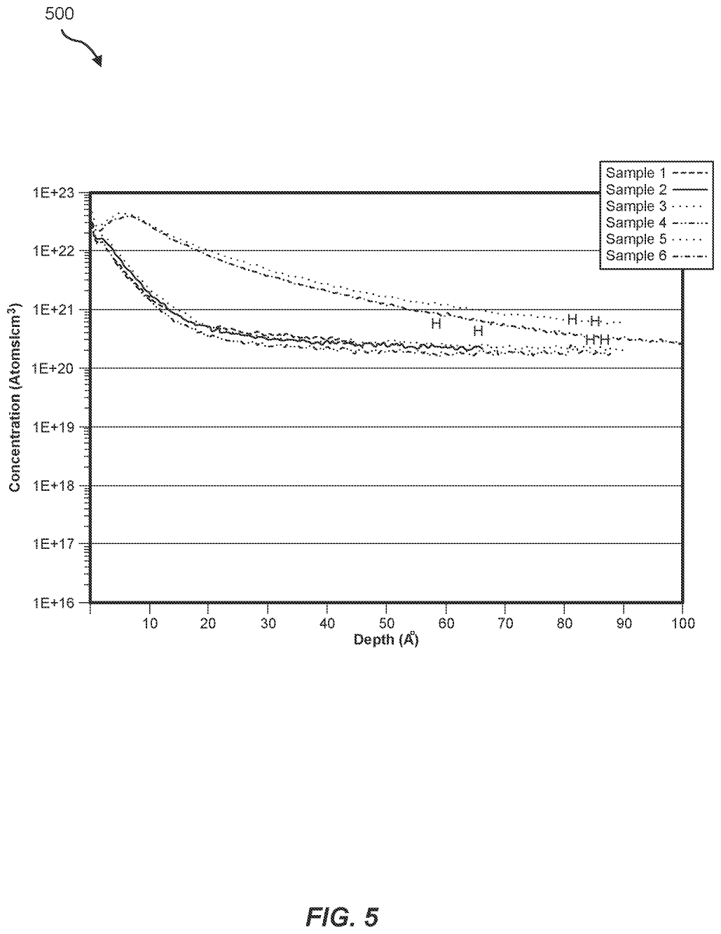

FIG. 5 illustrates example post-processing optical loss recovery. As shown in FIG. 5, a table 500 shows a concentration of hydrogen at various depths of six transparent substrate samples. All samples may have undergone an etching process, but only samples 3 and 6 may have been treated with a post-processing recovery treatment, such as one or more of the post-etch recovery steps described herein (e.g., including an H₂/Ar plasma treatment step). As can be seen in table 500, samples 3 and 6 may demonstrate significantly higher concentrations of hydrogen near the surface than do the remaining samples.

Embodiments of the present disclosure may include or be implemented in conjunction with various types of artificial-reality systems. Artificial reality may be a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

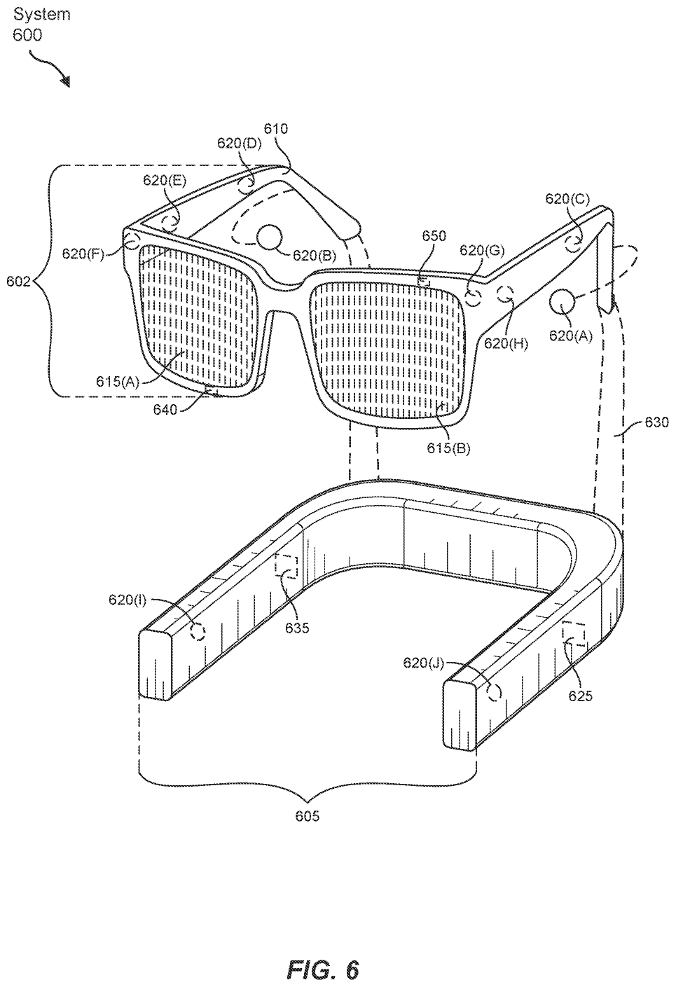

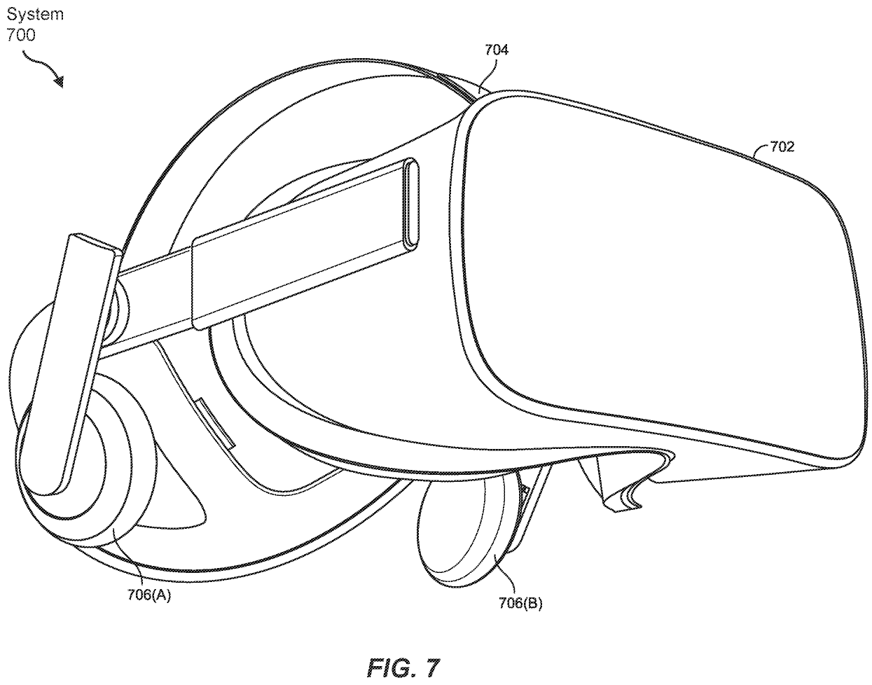

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 600 in FIG. 6) or that visually immerses a user in an artificial reality (such as, e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

In some examples, augmented-reality system 600 may also include a microphone array with a plurality of acoustic transducers 620(A)-620(J), referred to collectively as acoustic transducers 620. Acoustic transducers 620 may represent transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(1) and 620(J), which may be positioned on a corresponding neckband 605.

In some embodiments, one or more of acoustic transducers 620(A)-(J) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a BLUETOOTH connection). In still other embodiments, acoustic transducers 620(A) and 620(B) may not be used at all in conjunction with augmented-reality system 600.

Acoustic transducers 620 on frame 610 may be positioned in a variety of different ways, including along the length of the temples, across the bridge, above or below display devices 615(A) and 615(B), or some combination thereof. Acoustic transducers 620 may also be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on shoulders than they would tolerate on heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(1) and 620(J)) that are part of the microphone array (or potentially form own microphone subarray). Neckband 605 may also include a controller 625 and a power source 635.

Acoustic transducers 620(1) and 620(J) of neckband 605 may be configured to detect sound and convert the detected sound into an electronic format (analog or digital). In the embodiment of FIG. 6, acoustic transducers 620(1) and 620(J) may be positioned on neckband 605, thereby increasing the distance between the neckband acoustic transducers 620(1) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

In some examples, augmented-reality system 600 and/or virtual-reality system 700 may include and/or be examples of head-mounted displays.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and equivalents in determining the scope of the present disclosure.

Unless otherwise noted, the terms “connected to” and “coupled to” (and derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and derivatives), as used in the specification and claims, are interchangeable with and have the same meaning as the word “comprising.”

What is claimed is:

1. A method for recovering optical properties of transparent substrates, the method comprising:
performing a post-etching annealing process on a transparent substrate.

2. The method of claim 1, further comprising:
applying a plasma treatment to the transparent substrate.

3. The method of claim 2, further comprising:
performing an atomic layer etching treatment on the transparent substrate.

4. The method of claim 3, further comprising subsequently performing a cleaning process.

5. The method of claim 4, further comprising subsequently applying a surface passivation layer to the transparent substrate.

6. The method of claim 1, wherein the post-etching annealing process comprises an oxidative annealing process.

7. The method of claim 1, wherein the post-etching annealing process comprises a reductive annealing process.

8. The method of claim 1, wherein the post-etching annealing process comprises an oxidative annealing process and a reductive annealing process in sequence.

9. The method of claim 1, further comprising subsequently performing a cleaning process.

10. The method of claim 1, further comprising subsequently applying a surface passivation layer to the transparent substrate.

11. The method of claim 1, wherein the post-etching annealing process is performed at or below 1600 degrees Celsius.

12. The method of claim 1, wherein the post-etching annealing process is performed at or below 1400 degrees Celsius.

13. The method of claim 1, wherein the post-etching annealing process is performed at or below 1200 degrees Celsius.

14. The method of claim 1, wherein:
the annealing process comprises use of a mixture of H₂ gas and at least one of Ar gas or N₂ gas, wherein the H₂ gas comprises about 10 percent or less of the mixture of gas by volume;
the annealing process is performed at about 1200 degrees Celsius or less; and
the annealing process is performed for about 3 hours or less.

15. The method of claim 14, further comprising a plasma treatment process, wherein:
the plasma treatment process comprises use of a plasma treatment mixture of H₂ gas and at least one of Ar gas or N₂ gas, wherein the H₂ gas comprises about 10 percent or less of the plasma treatment mixture of gas by volume;
the plasma treatment process is performed at about 500 degrees Celsius or less;
the plasma treatment process is performed for about 1 hour or less; and
the plasma treatment process is performed with a radiofrequency power of about 1 kilowatt or less.

16. The method of claim 14, further comprising an annealing process, wherein:
the annealing process comprises use of gas comprising at least in part O₂;
the annealing process is performed at about 1200 degrees Celsius or less; and
the annealing process is performed for about 3 hours or less.

17. The method of claim 16, wherein:
the annealing process is performed at about 500 degrees Celsius or less;
the annealing process is performed for about 1 hour or less; and
the annealing process is performed with radiofrequency power of about 1 kilowatt or less.

18. The method of claim 14, further comprising performing a wet cleaning process.

19. A device comprising an etched transparent substrate modified with a post-etch annealing process.

20. A system comprising a head-mounted display comprising a waveguide modified with a post-etch annealing process.
